(19) United States
(12) Patent Application Publication
(10) Pub. No.: US 2009/0026660 A1
(43) Pub. Date: Jan. 29, 2009

(54) METHODS OF MAKING ANTIMICROBIAL VOICE PROTHESIS DEVICES

(75) Inventors: Jesse N. Nelson, Oxnard, CA (US); Edmund V. Seder, Santa Barbara, CA (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: HELIX MEDICAL, LLC, Plymouth, MI (US)

(21) Appl. No.: 12/164,800

(22) Filed: Jun. 30, 2008

Related U.S. Application Data
(63) Continuation-in-part of application No. 10/990,168, filed on Nov. 15, 2004.
Application No. 10/990,168 is a continuation-in-part of application No. 10/487,614, filed on Feb. 19, 2004, now Pat. No. 6,948,526.
Application No. 10/990,168 is a continuation-in-part of application No. 10/923,138, filed on Aug. 19, 2004, now Pat. No. 7,393,547.
Application No. 10/923,138 is a continuation-in-part of application No. 09/833,961, filed on Apr. 11, 2001, now abandoned.
(60) Provisional application No. 60/344,444, filed on Dec. 28, 2001.

(51) Int. Cl. B29C 45/00

(52) U.S. Cl. 264/331.13

(57) ABSTRACT

Microbial growth on the surface of a valve of a voice prosthesis and optionally the cartridge or ring supporting the valve, is inhibited by providing antimicrobial activity at a level sufficient to retard growth of a microbial film by dispersing an inorganic antimicrobial agent such as silver oxide or an organic antimicrobial agent such as triclosan or butyl paraben dispersed in a medical grade silicone elastomer. The valve, ring or cartridge is in contact with body fluids containing microorganisms and nutrients therefor. The antimicrobial surface can interfere with or inhibit the growth of a biofilm, bacterial layer or a yeast layer. The body of the prosthesis may also contain an antimicrobial surface as long as it is non-toxic to the tissue it contacts. Methods of making such antimicrobial components for voice prosthesis devices are also provided.

### CROSS-REFERENCE TO RELATED APPLICATIONS

This application is a continuation-in-part of U.S. Utility application Ser. No. 10/990,168 filed on Nov. 15, 2004; which is a continuation-in-part of U.S. Utility application Ser. No. 10/487,614 filed on Feb. 19, 2004, which is a 371 National Stage Application based on International Application PCT/US02/41274 filed on Dec. 20, 2002, which claims the benefit of U.S. Provisional Application No. 60/344,444 filed on Dec. 28, 2001; and a continuation-in-part of U.S. Utility application Ser. No. 10/923,138 filed on Aug. 19, 2004, which is a continuation-in-part of U.S. Utility application Ser. No. 09/833,961 filed Apr. 11, 2001. The above identified applications are each incorporated by reference in their respective entireties.

### FIELD

The present disclosure relates to microbial-resistant medical devices and, more particularly, to voice prosthesis medical devices having one or more components which retard growth of microbial organisms and methods for making such voice prosthesis devices.

### BACKGROUND

Medical devices, particularly synthetic resin prosthetic devices which are used in environments where micro-organisms such as fungi or yeast and/or bacteria are actively growing, can become covered with a biofilm colonized layer to the point where the function of the device is impaired. After growth of the biofilm microbial layer, filaments can grow and descend into the body or wall of the polymeric device and detrimentally affect its physical properties until the device no longer functions. The fouled device must be cleaned or discarded.

Whenever a prosthesis is in contact with moisture in a warm, dark environment, the surfaces are subject to microbial growth, usually containing a predominant amount of Candida usually mixed with bacteria. The microbial growth can interfere with the functioning of the prosthesis, requiring removal of the prosthesis for disposal or cleaning. The microbial growth is a persistent problem in the management and care of patients who have had their larynx removed and utilize a voice prosthesis, since the prosthesis is exposed to a non-sterile, humid, warm, nutrient rich environment.

There are several options for restoring speech to patients who have had their larynx removed. One procedure is to surgically create a puncture or fistula between the trachea and the esophagus. A tracheoesophageal voice prosthesis containing a one-way valve such as a BLOM-SINGER® voice prosthesis is inserted into the tracheoesophageal fistula. The one-way valve protects the airway during swallowing but opens under positive pressure from the trachea. The voice prosthesis, thus, permits a patient to divert air from the lungs into the esophagus and out through the mouth. Speech is created during passage of air through the upper part of the esophagus.

The prosthesis maintains the fistula open, transfers air from the trachea to the esophagus for voice production and prevents esophageal leakage into the trachea during swallowing. The oral cavity which extends into the throat has a high microbial population. However, the prosthesis being in contact with moisture in a warm, dark, nutrient rich environment is subject to growth of commonly found micro-organisms, typically Candida on the valve and the retaining flange. The microbial attack is currently being studied. The microbial attack organisms and sequence of events are quite complex and are still undetermined. The microbial growth on and into the soft silicone resin can interfere with function of the valve and can cause the flange to wrinkle and the valve to leak. The fouled device must be cleaned or discarded and replaced with a new device.

One type of current low pressure voice prosthesis can be removed by the patient every few days and can be replaced with a clean prosthesis. The removed prosthesis is soaked in hydrogen peroxide to sterilize and clean the valve and flange. Some patients however, have difficulty managing frequent removal and reinsertion of the prosthesis. Others, who are physically handicapped are not able to remove, sterilize, or reinsert the prosthesis.

A longer dwelling, low pressure voice prosthesis has been developed that can remain in place in the tracheoesophageal fistula for many weeks or months, depending on the patient and conditions of use. The patient can confidently use the prosthesis for longer periods. The longer dwelling voice prosthesis is not removable by the patient. Trips to a health care specialist to remove and replace the prosthesis are greatly extended providing increased comfort and lower cost to the patient.

Another type of soft voice prosthesis includes a rigid stiffening ring 14 inserted into a groove in the soft body of the prosthesis. Though the ring stiffens the body adjacent the valve it does not prevent distortion of the body by muscular movement or distortion of the valve by growth of yeast for longer durations.

U.S. Pat. No. 5,578,083 issued Nov. 26, 1996, discloses the use of a stiff cartridge to support a soft silicone prosthesis and to provide a seat for the valve which is connected to the cartridge by a tab in slot design. Another cartridge-valve design includes a one piece sleeve-valve which is stretched over and seats in a cylindrical groove in the cartridge as disclosed in U.S. Pat. No. 6,948,526 issued on Sep. 27, 2005 to Seder et al. (filed as U.S. application Ser. No. 10/487,614 filed on Feb. 19, 2004), the disclosure of which is incorporated herein by reference. However, microbial growth can still proceed to a point at which the valves can not be reliably sealed.

Microbial growth on the valve can also cause distortion of the shape of the valve or form wrinkles in the body of the valve which prevents the valve from closing. Leaking also appears to be due to distortion of the valve body adjacent to the seat of the valve and to microbial growth on the seat. Forming the valve with an arcuate dome shape increased resistance to folding or bending of the valve. However, some valves still leak after extended placement in a fistula.

The use of silicone elastomer is limiting because of the open matrix nature of the material. The open nature of silicone allows microorganisms to attach to and sometimes burrow through the material. The attachment of microorganisms at the valve seat interface can interfere with creating a seal. Attachment of microorganisms to the flexible hinge area can reduce the flexibility of the hinge, and can also be a precursor for other microorganisms to burrow into the silicone, effectively changing the shape of the silicone and thereby interfering with the ability for the valve to seal correctly. In extreme cases, microorganisms can attach and burrow into the esophageal side of the valve to the point where the sealing seat of the valve is altered in shape.

Historically, microbial in-growth resistance has come from selection of hard plastics and metals that reduce attachment of microorganisms to certain components. These materials were restricted from use in the hinge area and other areas that required flexibility and resilience. The components requiring this flexibility and resilience have traditionally been molded from silicone elastomer.

In other medical devices, antimicrobial coatings have been available for some years. Coatings typically do not last the lifetime of the product on the highly flexible hinge, as the coating tends to flake off. Once this happens, the hinge is left unprotected and is exposed to the detrimental effects of microorganisms and their growth.

Application of antimicrobial substances to silicone articles can also come by way of solvent introduction. In this method, the silicone part is soaked with a solvent containing a dissolved antimicrobial agent. The silicone part is removed from the solvent and the solvent is allowed to evaporate. The dissolved antimicrobial agent is then deposited in the matrix of the silicone elastomer. There are several variations of this method. This method is limited to antimicrobial agents that are soluble in an effective solvent and to the uncertainty of exact load level. This method also requires the additional steps and regulations associated with working with solvents.

The use of polymers having antimicrobial properties is disclosed in PCT Publication No. WO 98/04463 published March 1998. Though voice prosthesis devices formed of fluorosilicone polymers, such as those set forth in WO 98/04463, showed some initial success, examination of returned devices from a clinical study showed significant microbial growth on both the posterior aspect and periphery of the valve flap and on the inner surface of the valve hood which interfered with movement of the valve flap. Any further use of the fluorosilicone device was abandoned.

### SUMMARY

In various aspects, the present disclosure provides a method for making an antimicrobial component for a voice prosthesis device. The method comprises mixing part A and part B of a silicone elastomer, an antimicrobial work-time altering agent comprising silver oxide; and an inhibitor to form a curable elastomer mixture. At least one of Part A and Part B includes an initial amount of an initial inhibitor and the inhibitor added during the mixing is provided at a second amount effective to increase a work-time of the curable elastomer mixture. The method further comprises forming a component having antimicrobial properties for the voice prosthesis device by curing the silicone elastomer mixture.

In other aspects, the present teachings provide methods for making an antimicrobial valve element for a voice prosthesis device, where the method comprises: mixing part A and part B of a silicone elastomer, an antimicrobial work-time altering agent comprising silver oxide; and an inhibitor to form a curable elastomer mixture. At least one of Part A and Part B includes an initial amount of an initial inhibitor and the inhibitor added during the mixing is provided at a second amount effective to increase a work-time of the curable elastomer mixture. A valve element is formed that comprises a valve flap having antimicrobial properties for the voice prosthesis device by curing the silicone elastomer mixture.

In yet other aspects, the present disclosure provides a method for injection molding an antimicrobial component for a voice prosthesis device. The method comprises presenting Part A and Part B of a curable silicone elastomer wherein at least one of Part A and Part B includes a first amount of a first inhibitor. Part A, the Part B, a second amount of a second inhibitor, and an antimicrobial work-time altering agent comprising silver oxide are mixed to form a curable and flowable silicone elastomer dispersion for injection molding. The second amount of the second inhibitor added during mixing is related to an amount of the antimicrobial work-time altering agent present in the dispersion and is effective to increase a work-time for injecting the dispersion. In the absence of the second amount of inhibitor, a comparative mixture of the Part A, the Part B, and the antimicrobial work-time altering agent comprising silver oxide has a comparative work-time that is less than the work-time of the system having the second amount of inhibitor. The dispersion is injected into a mold for a component of the voice prosthesis device and conforms to a contour of the mold during injecting. Lastly, the curable silicone elastomer dispersion is cured to form the component having antimicrobial properties for the voice prosthesis device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic view of a voice prosthesis installed in a tracheoesophageal fistula;

FIG. 2 is a view in section of an assembly of the valve, cartridge and body of an embodiment of the voice prosthesis of the disclosure;

FIG. 2a is an enlarged sectional view of the valve securing means shown in FIG. 2 for purposes of clarity;

FIG. 3 is a side view in elevation of the valve shown in FIG. 2;

FIG. 4 is a front view in elevation of the valve shown in FIG. 2;

FIG. 5 is a rear view in elevation of the cartridge shown in FIG. 2;

FIG. 6 is a view in section taken along line 6-6 of FIG. 5;

FIG. 7 is a view in section taken along line 7-7 of FIG. 6;

FIG. 8 is a bottom view in elevation of the cartridge illustrated in FIG. 2.

FIG. 9 is a top view in elevation of the prosthesis illustrated in FIG. 9;

FIG. 10 is a view in section taken along line 10-10 of FIG. 9.

FIG. 11 is a view in section of a second embodiment of valve with seating band according to the disclosure;

FIG. 12 is a view in section of a hard cartridge with valve seat according to the disclosure;

FIG. 13 is a view in section of a soft body for a voice prosthesis according to the disclosure;

FIG. 14 is a view in section of the assembly of the body, cartridge and valve illustrated in FIGS. 11-13;

FIG. 15 is a top view in elevation of an alternate embodiment of a valve;

FIG. 16 is a perspective and sectional view of the valve illustrated in FIG. 15;

FIG. 17 is a view in section taken along lines 17-17 of FIG. 15;

FIG. 18 is a perspective view of an alternate embodiment of a cartridge;

FIG. 19 is a top view in elevation of the cartridge illustrated in FIG. 18;

FIG. 20 is a view in section taken along lines 10-10 of FIG. 19;

FIG. 21 is a perspective sectional view of the assembly of a valve with the cartridge illustrated in FIG. 18;

FIG. 22 is a top view in elevation of the assembly illustrated in FIG. 21;

FIG. 23 is a view in sections taken along lines 23-23 of FIG. 22; and

FIG. 24 is a view in section illustrating the use of a metal sleeve to isolate and support the valve.

### DETAILED DESCRIPTION

The following description is merely exemplary in nature and is not intended to limit the present disclosure, application, or uses. In certain aspects, the technology will be illustrated by various embodiments of a long-dwelling voice prostheses, including an embodiment with a hard cartridge and a soft body voice prosthesis, though it is applicable to any prosthetic or medical device disposed in a body cavity having an environment conducive to growth of micro-organisms such as Candida Albicans.

In U.S. Patent Publication No. 2002/0193879 to Seder et al. (U.S. patent application Ser. No. 09/833,961) (hereinafter “Seder et al.”), the content of which is incorporated herein, antimicrobial agents can be compounded (i.e., embedded) into those portions of a prosthesis that are not in contact with tissue. The antimicrobial portions of the device remain free of microbial growth for an extended period which contributes to longer use of the prosthesis in vivo. For example, the valve in most voice prostheses is not in contact with tissue. It is only in intermittent contact with body fluids. The same is true of the inside surface of the tubular prosthesis and/or the facial and inside surfaces of rings or cartridges that are present to reinforce the soft body of a prosthesis.

In certain aspects, when soft prosthesis were compounded with antimicrobial agents such as silver compounds at a level which resists growth of microorganisms, it was discovered that in certain circumstances, the prosthesis was irritating to and/or toxic to tissue in contact with the prosthesis. It has been discovered in accordance with the present disclosure that antimicrobial agents can be compounded into parts of a prosthetic that are not in contact with tissue. The antimicrobial parts will be free of microbial growth for an extended period which contributes to longer use of the prosthesis in vivo.

The isolation of the valve from tissue is enhanced by recessing the valve forward of the rearward edge of the prosthesis and/or forward of a flange which seats the prosthesis in a tracheoesophageal fistula. The body of the prosthesis may have some antimicrobial properties as long as the surface of the body is not toxic to tissue. For example, the body can be formed of a polyurethane polymer which resists attachment of a biofilm or a microbial layer. Thus, in accordance with the present teachings, by adding an amount of microbial agent effective to resist growth onto (or into) components of the voice prosthesis device, such as the valve, ring or cartridge, it is found that microbial growth is delayed for a significant period without any evidence of irritation or toxicity to the tissue.

Seder et al. further teach that the antimicrobial agent-bearing elastomer can be compounded by dispersion of the antimicrobial agent into the raw elastomer material. Thus, antimicrobial agents can also be compounded by dispersion into the raw material. For example, silicone elastomer can contain at least 10 percent of an antimicrobial agent such as silver, or silver compounds such as silver oxide. By way of further example, a silicone elastomer can contain up to 100 per hundred resin (phr) of an antimicrobial agent, such as silver or silver compounds like silver oxide. In certain aspects, the antimicrobial agent comprising silver oxide is present at about 5 up to less than about 50 phr of silver oxide. Other suitable antimicrobial compounds such as, for example, gold, platinum, copper, zinc metal powder or oxides and salts thereof, can be used in the non-tissue contacting portions of the prosthesis.

In certain aspects, preferred organic antimicrobial agents that can be added to the valve are organic antimicrobial agents that can be dispersed throughout the silicone raw material are a food grade preservative such as an aromatic carboxylic acid or C₁ to C₉ a ester thereof, such as butyl paraben, butyl p-hydroxy benzoate, or an alkene carboxylic acid salts such as alkali metal sorbate salt or a halohydroxy aromatic ether, such as triclosan (2,4,4′-trichloro-7′-hydroxydiphenyl ether).

The agents can be dispersed throughout a silicone by milling a dry powder into liquid resin before curing, by predissolving in minimum amount of solvent and then mixing or milling the solution into the liquid resin or heating the agent above its melting temperature, but below its decomposition temperature and mixing the molten material with the liquid resin before molding. The agents are chosen to be sufficiently robust to survive the molding process. A more complete discussion of prior art methods for incorporating antimicrobial agents into, or upon, a prosthesis is also presented in Seder et al.

However, in accordance with the present disclosure, it has been discovered that metal oxides, such as silver oxide, which have desirable antimicrobial properties in vivo, also accelerate the curing of silicone elastomers used to form the valve leading to uneven dispersions and short pot life. Thus, one problem with prior art methods of dispersing an antimicrobial agent such as Ag₂O into an elastomer prior to forming a prosthetic article therefrom is the short work-time available for forming the elastomer into a prosthesis or a portion thereof, after compounding; sometimes the work-time being as short as a minute or two. It is, therefore, desirable to provide a method for incorporating an antimicrobial agent such as, for example, silver oxide, into an elastomer such as silicone that provides a longer work-time for fabricating an article, such as a component for a voice prosthesis, therefrom.

In accordance with certain aspects of the disclosure, the pot life of silicone components for voice prosthesis devices containing silver oxide, such as valves, can be increased by adding a curing inhibitor to the composition before curing to lengthen work-time.

Valves and cartridges for voice prosthesis have been compounded with a dispersion of antimicrobial agents and were subjected to in vitro and in vivo testing. The valves and cartridges are found to exhibit significant inhibition of microbial growth. The presence of the antimicrobial agent throughout the matrix will retard both surface attachment and penetration of microorganisms into the valve.

Another aspect of the disclosure is to prevent unseating of the valve or distortion of the valve and/or cartridge due to muscle action of the stoma and to further isolate the valve from microorganisms carried by saliva. In certain aspects, the hard cartridges or rings are suitably formed of a hard engineering plastic such as polyvinylidene fluoride, commercially sold under the tradename KYNAR™. The cartridges can also contain a uniform dispersion of an organic antimicrobial agent as disclosed above. In accordance with certain aspects of the disclosure, a metal sleeve suitably formed of titanium surrounds the portion of the cartridge supporting the valve and its attachment means.

These and many other features and attendant advantages of the technology will become apparent as the technology becomes better understood by reference to the following detailed description when considered in conjunction with the accompanying drawings.

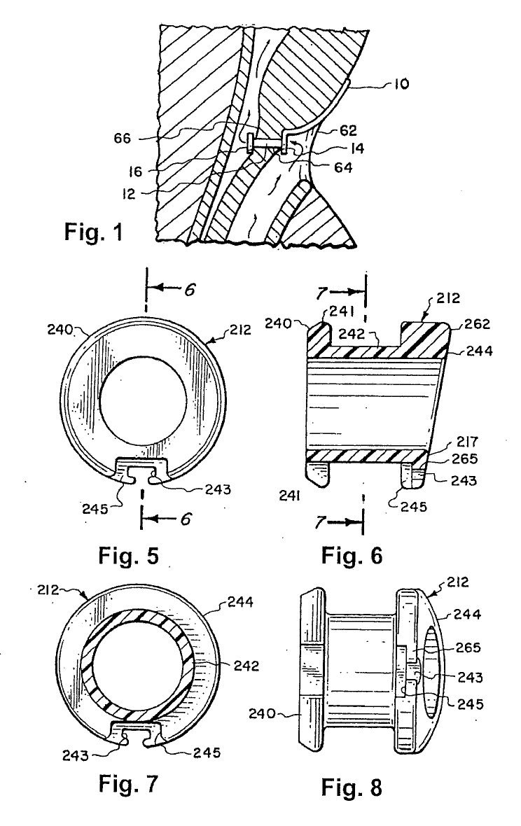

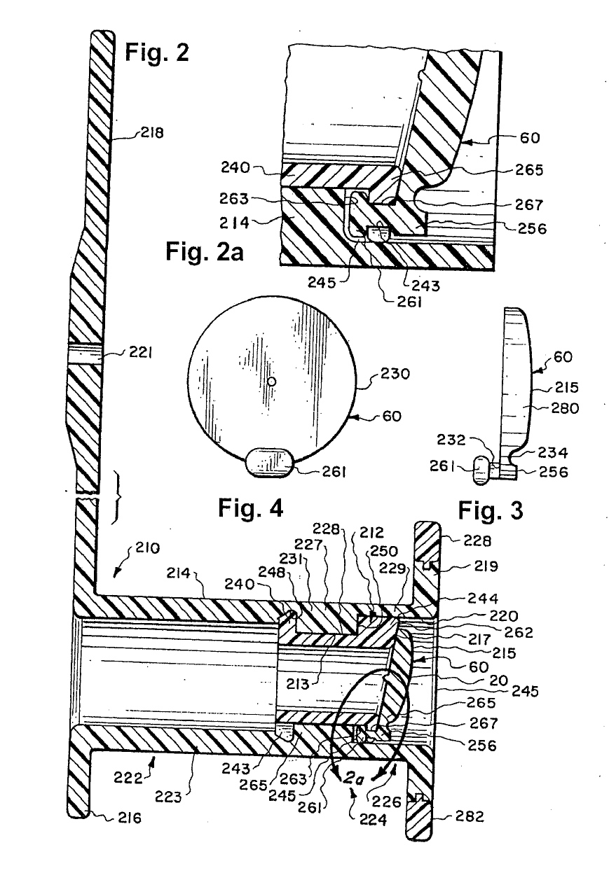

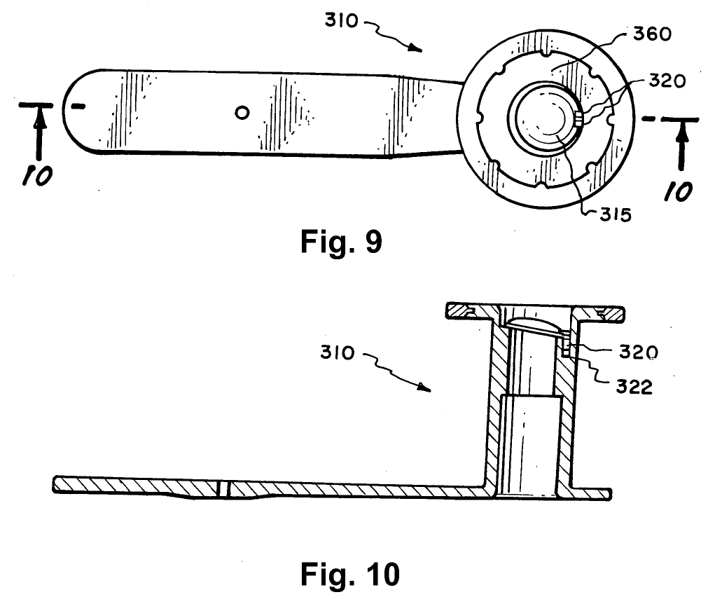

Referring now to FIGS. 1 and 8-9, a first embodiment of a voice prosthesis 10 is shown inserted into a fistula 62 with the front flange 14 engaging the outer wall 64 of the trachea and the rear flange 16 engaging the wall 66 of the esophagus. The body 12 of the prosthesis 10 prevents the fistula 62 from closing. The body 12 and flanges 14, 16 are formed of an elastomer material which is non-toxic to tissue. The prosthesis 10, 310 also contains a valve 60, 360 as shown in FIGS. 2-4 and FIGS. 8, 9 which has an antifungal surface 215, 315 toxic to tissue. The valve 60, 360 is preferably separately molded and has a flap 20 or two posts 320 which are attached to the prosthesis 10, 310. In the soft prosthesis 310, the posts 320 are received in cavities 322 in the body and secured thereto by potting with a biocompatible adhesive such as a room temperature vulcanization (RTV) silicone adhesive. The valve could also be mounted in a rigid sleeve attached to the distal end of the cartridge.

Referring again to FIGS. 2-4, a long dwelling prosthesis 210 can further contain an internal, rigid cartridge 212 which reinforces the body 214 of the soft prosthesis as shown in FIGS. 2-8 and as disclosed in U.S. Pat. No. 5,578,083, the disclosure of which is expressly incorporated herein by reference.

Referring particularly now to FIGS. 2 and 2a, a preferred voice prosthesis 210 is formed of a tubular body 214, a hollow, rigid cartridge 212 received in a channel 213 through the body 214 and a flapper valve 215 mounted on the rear face 217 of the cartridge 212.

A front tracheal flange 216 and a rear retention esophageal flange 219 are connected to the ends of the body 214. A flexible tab 218 can be attached to the front flange 216. The tab 218 can contain an aperture 221 which can be connected to an insertion tool, not shown. The body 214, front flange 216 and rear flange 219 are preferably a single molded, unitary structure formed from a biocompatible elastomer such as silicone resin, suitably a 50 durometer, medical grade, silicone elastomer. Since the resin is transparent and the prosthesis structure is small, the prosthesis is difficult to visualize and handle. Therefore, the molding resin generally, but not always, can contain a small amount, from 0.1 to 0.5% of a biocompatible pigment to aid in seeing the device. The pigment can be a heavy metal salt such as barium sulfate. The cartridge 212 can be formed of an inert, self-lubricating thermoplastic polymer, a fluorinated resin such as polyvinylidene fluoride (KYNAR™), a semi-crystalline, low molecular weight polymer of vinylidine fluoride, such as TEFLON™ (polytetrafluoroethylene) or a polyalkylene resin, such as polyethylene or polypropylene.

The tubular body 214 has a first section 222 having a wall 223 of a first thickness, a central section 224 having a wall 227 of a greater thickness and a third wall section 226 having a wall 229 of reduced thickness. The central wall section 224 forms a cylindrical boss 231 which is received in an annular channel 228 formed in the outer wall of the cartridge 212.

The hollow cartridge 212 has a front flange 240, a rear flange 244 forming a central channel 242 between the flanges 240, 244. The cartridge 212 is assembled with the body 214 by inserting the front flange 240 of the cartridge 212 into the rear opening 245 of the body 214 and forcing it through the central channel 213 of the body compressing the boss 231 until the front flange 240, seats against the end wall 248 of the boss 231 and the rear flange 244 seats against the rear wall 250 of the boss 231.

Referring now to FIGS. 3 and 4, the rear flange 244 has a horizontal slot 243 for receiving a tab 232 mounted on the front face of the valve 60 which communicates with an enlarged recess 245. The remaining volume in the recess 245 can be filled with biocompatible adhesive such as a silicone adhesive. Preferably, the tab 232 contains a bulbous end 261 which seats in the recess 245. The rear face 262 of the rear flange 244 can be angled to the vertical in order to preload the valve 60. Usually the angle is from about 1 to about 20 degrees, preferably about 3 to about 10 degrees.

Referring further to FIGS. 3 and 4, the flapper valve 60 has a round segment 230 connected to an attachment flap 256. A live hinge 234 in the form of a score line separates the segment 230 from the flap 256. A tab 232 is provided on the flap 256 for attaching the valve 60 to the body of the cartridge 212.

The hinge is located adjacent the lower, recessed portion of the rear face of the flange 244 which preloads the valve 60. The valve 60 is further strengthened by the increased thickness of the dome-shaped rear face 280 of the round segment 230. Leakage of the valve is further decreased due to the seating of the valve element 60 on the hard, smooth outer surface 217 of the rear flange 244 of the cartridge.

In order to assure that the rear flange 219 of the body 214 is fully seated on the esophageal wall surrounding a fistula, a narrow opaque ring 282 can be attached to or molded into the rear flange 219 as disclosed in U.S. Pat. No. 5,480,432 on Jan. 2, 1996, the disclosure of which is expressly incorporated herein by reference. An opaque pattern can also be provided by depositing opaque dots such as tantalum on the flange. The ring 282 has a width at least 10% the diameter of the rear flange usually from 10% to 50% the diameter of the annular rear flange. Usually the rear flange has a diameter of about 0.5 inch and the ring has a width of about 0.05 to 0.10 inch. The ring 282 preferably has an outer perimeter coincident with that of the rear flange 219 so that folds anywhere on the rear flange will be detected by the displayed image of the ring 282. The ring is preferably formed of the same flexible resin as the rear flange, but contains an amount of radiopaque pigment such as barium sulfate sufficient to render the ring opaque to X-rays. Usually the pigment is present in an amount from at least 5% to 35%, generally around 20% by weight.

The front flange 240 of the cartridge 212 can have a bevel 241 so that it is easier to move the front flange 240 past the boss 231 on the body 214 of the device.

The body 214 can also contain a recess 220 placed forward of the rear flange 219 to further protect the valve from failing by further isolating the valve from contacting tissue. A hood may also be provided rearward of the flange 219.

Referring more particularly now to FIGS. 5-10, the front flange 240 and the rear flange 244 of the hard cartridge 212 may contain key shaped slots 243, 245 which cooperate with a key bar 265 on the bottom of the soft tubular body 214. The rear end 267 of the key bar 265 bears against the bulbous end 261 of the flexible tab 256.

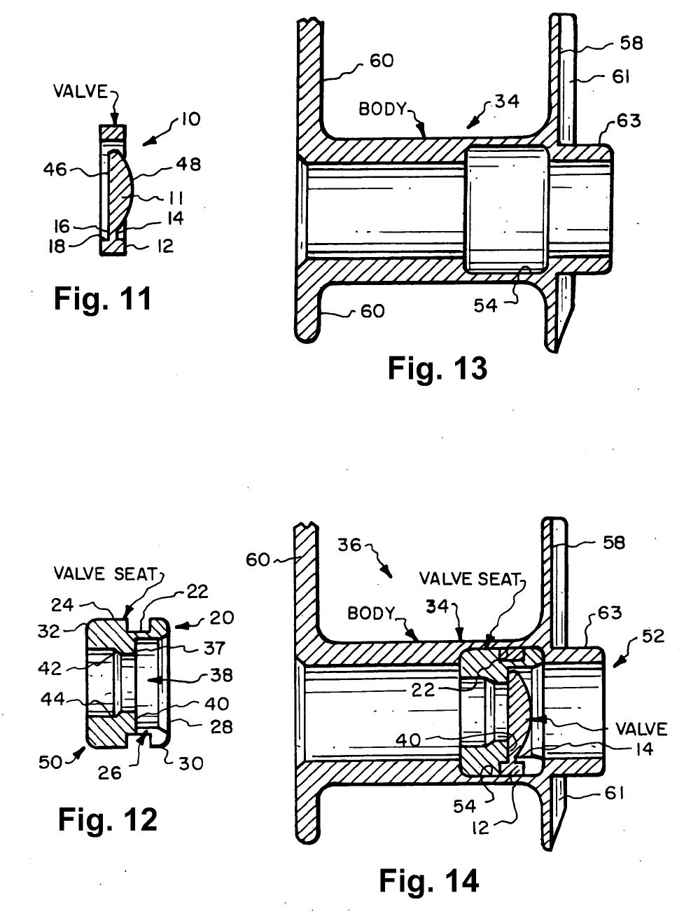

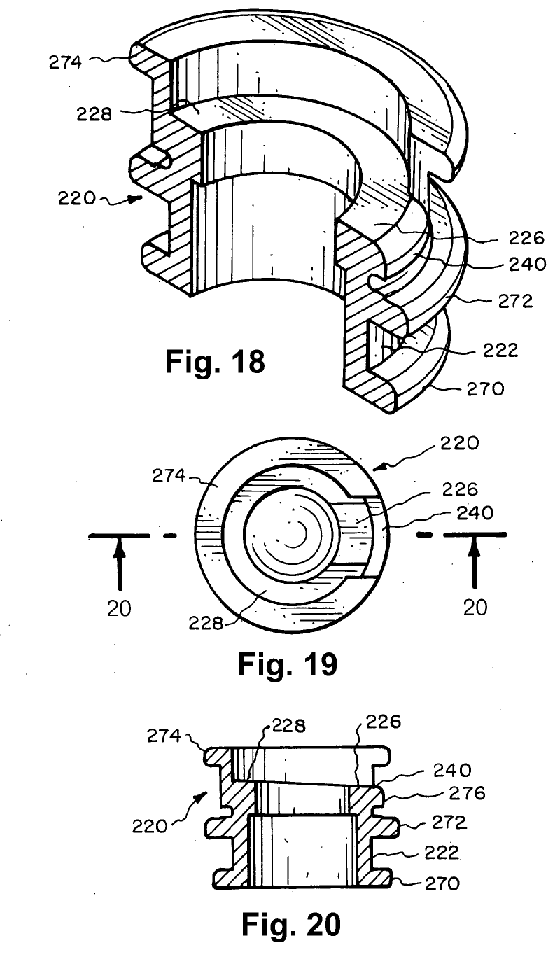

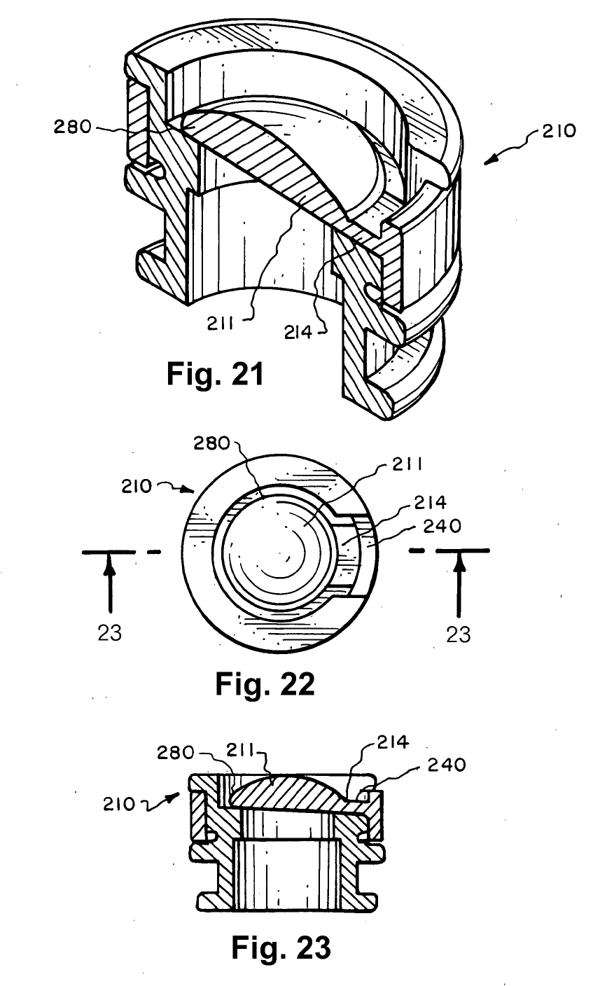

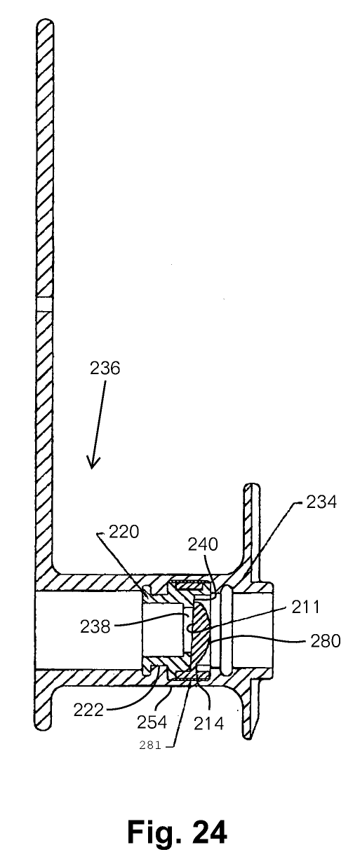

Referring now to FIGS. 11-24, an elastomer flapper valve 210 formed of a valve element 211 spaced from and connected to a surrounding, continuous mounting band 212 by a tab 214 extending from the outer surface 216 of the valve element to inner surface 18 of the band 212. The rigid cartridge 220 (shown in FIG. 18) has a groove 222 formed in the outer surface 224 and a slot 226 formed in the distal surface 228 extending from the distal surface 228 to the groove 222. The width of the slot 226 is coextensive with the width of the tab 214. The outer edges of the distal surface 228 are rounded at 230 to prevent tearing of the mounting band 212 as it is assembled with the cartridge 220. The outer edge 232 of the proximal surface of the cartridge 220 can also be chamfered or rounded to prevent tearing of the soft body 234 of the voice prosthesis 236.

The cartridge 220 contains a boss 236 extending into the channel 238 through the cartridge forming on its distal surface a seat 240 for the valve element 211. The seats 240 can be disposed normal to the axis of the channel or can be slanted at an angle of 5-10 degrees as illustrated in FIG. 19. The proximal face 242 of the boss 236 can be utilized to engage the distal end of a cleaning brush or insertion tool. The edge 244 of the proximal face 242 can be chamfered.

Referring again to FIGS. 11 to 14 the voice prosthesis 236 is assembled by stretching the band 212 while aligning the tab 214 with the slot 226. The stretched band 212 is then placed over the groove 222 while the tab 214 is seated in the slot 226 against the seat 240 and released into the groove 222. The proximal face 246 of the valve element 211 is reliably seated against the valve seat 240. The valve element 211 may have a dome shape 248 to strengthen the element and prevent wrinkling of the element.

The cartridge-valve assembly 250 is then pushed through the distal end 252 of the soft body 234 until it seats in the annular recess 254 within the soft body 234. The soft body 234 can also contain a conventional distal flange 258 and proximal flange 260 for engaging the surfaces of wall between a trachea and esophagus. A reinforcement ring 281 may be disposed around the soft body 234 region to provide additional structural rigidity to cartridge, when necessary, and is formed of rigid material, like titanium metal. The distal flange 260 can contain a radioplaque ring in order to assure that the flange 60 is correctly seated as disclosed in Ser. No. 08/282,277 filed Jul. 27, 1994 now issued as U.S. Pat. No. 5,480,432, the disclosure of which is expressly incorporated herein by reference. The soft body 234 can contain a distal hood 263 to further protect the valve element from being fouled.

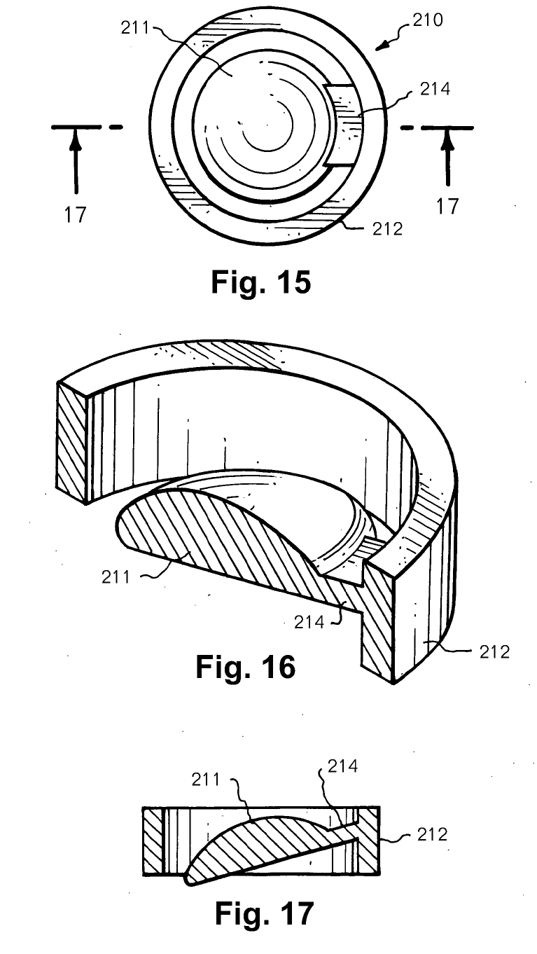

Referring now to FIGS. 15-17, an alternate embodiment of a valve 210 can be preloaded by forming the tab 214 at an angle from 5 to 20% to a plane normal to the axis of the mounting band 212. The valve element 211 will preload when assembled with a cartridge, not shown.

Referring now to FIGS. 18-20, another way to preload a valve element, not shown, is to form the seating face 240 of a cartridge 220 at an angle of 5-20 degrees by disposing the face 240 at the slot 226 forward of the opposed face 228. The cartridge 220 illustrated in FIGS. 18-20 contains three flanges, a proximal flange 270, a central flange 272 and a distal flange 274 forming a first groove 222 between flanges 272 and 274 for receiving a mounting band of a valve, not shown and a second groove 276 for receiving a cylindrical boss on the body of a prosthesis, not shown, for better securing the assembly of the soft body and the cartridge 220.

Referring now to FIGS. 21-23 a valve 210 is illustrated assembled with the cartridge 220. The edge portion 280 of the valve element 211 opposite the tab 214 is preloaded by being faced rearwardly by the slanted seating surface 240.

Providing a microbial resistant valve according to the disclosure may eliminate or reduce the need to utilize a thick domed valve and a thicker, stiffer rear flange. Since the growth of a thick biofilm layer will be inhibited, warping of the valve is reduced or eliminated. The microbial resistant valve is formed by dispersing a microbial agent such as metal, metal oxide or salt or organic antimicrobial agent into the biocompatible resin.

The preferred manner of providing a surface resistant to microbial growth is to disperse the agent in the resin forming the portion of the device not in direct contact with body tissue. As noted previously above, the agent can be inorganic such as a salt or oxide of silver, gold, platinum, zinc or copper, or an organic material soluble or dispersible in the resin forming the valve or the cartridge, such as hydroxy aromatic carboxylic acids, esters thereof or halogenated phenols. In certain aspects, a preferred antimicrobial agent comprises silver oxide (Ag₂O). The agent is present in the resin or at least in a surface layer in an amount effective to deter microbial growth and at a concentration that can be toxic to tissue. The portions of the device in contact with tissue can contain a much lower concentration of the microbial agent at a level non-toxic and non-irritating to tissue.

For example, in the case of silver oxide, in certain embodiments, the concentration of silver oxide effective to deter growth of microbial biofilm is from 1 to 50 parts per hundred resin (phr), preferably 8 to 25 phr. The body of the device which is in direct contact with tissue can be compounded to include from 0.1 to 2 phr, preferably 0.5 to 1.0 phr of silver oxide.

The following experiments were conducted to determine the biocompatibility requirements of compounding silver oxide into bodies and valves of voice prosthesis at different concentrations and of coating the outside surfaces of a voice silicone elastomer prosthesis and valve with vaporized metal coatings by the SPIRE® process. The silver oxide was dispersed in the resin, molded to form a soft voice prosthesis body valve or disc and then cured. The silicone parts were tested in solution proportional to their size.

Cytotoxicity testing was performed on various concentrations of silver oxide and silicone elastomer, and on various combinations of bodies and valves. MEM (Minimum Essential Medium) Elution and Agarose Overlay tests were done. It was decided that the most applicable test, given the use of the voice prosthesis, is the MEM test, as it tends to be more sensitive. The Agarose overlay test is useful to help determine comparative degrees of toxicity for the different percentages of silver oxide.

TESTS PERFORMED

| | AGAROSE | |
|---|---|---|
| MATERIAL | OVERLAY | MEM |
| 14% Ag₂O | | |
| Q7-4750 w/14% Ag₂O (valves) | | Nontoxic |
| 10% Ag₂O | | |
| 10% Ag₂O sample discs | Toxic | |
| 10% Silver sample discs | Nontoxic | |
| Q7-4750 w/10% Ag₂O (10 units) | | Nontoxic |
| Q7-4750 w/10% silver (10 units) | | Nontoxic |
| Q7-4750 w/10% Ag₂O (valves) | | Nontoxic |
| Q7-4750 w/10% Ag₂O (bodies) | Toxic | Toxic |
| Q7-4750 body w/10% Ag₂O valve | | Nontoxic |
| 1.0% Ag₂O bodies/10.0% valves | | Intermediate |
| 0.5% Ag₂O bodies/10.0% valves | | Nontoxic |
| 8% Ag₂O | | |
| 0.5% Ag₂O bodies/8.0% valves | | Nontoxic |
| 5% Ag₂O | | |
| Q7-4750 body w/5% Ag₂O valve | | Nontoxic |
| Q7-4750 w/5% Ag₂O (bodies) | Toxic | Toxic |
| 2% Ag₂O | | |
| Q7-4750 w/2% Ag₂O (bodies) | Toxic | Intermediate |
| 0.5% Ag₂O | | |
| Q7-4750 w/0.5% Ag₂O (bodies) | Nontoxic | Nontoxic |
| 2% Gentian Violet | | |
| Q7-4750 w/2% Gentian violet (discs) | Toxic | |
| 2% Copper Oxide | | |
| Q7-4750 bodies w/2% Copper Oxide valves | Nontoxic | Nontoxic |
| Q7-4750 Control | | |
| Q7-4750 bodies w/2% Copper Oxide valves | | Nontoxic |

The tests showed that 10% silver oxide could be used in the valves if the bodies were straight silicone elastomer, or contain a very low percentage of silver oxide. However, the 10% silver oxide valves seems to be the upper end of toxicity.

The bodies and valves at 10% showed different results. They were tested in solution proportional to their size (theoretically), yet the bodies consistently showed a more toxic response than the valves. A theory is that the bodies simply had a greater mass even when this was compensated for in choosing the solution size, so more silver oxide was able to leach out into the test medium.

Based on these tests, in-vitro test discs were prepared using 5% and 10% silver oxide concentrations, and the clinical voice prosthesis units were prepared using 10% silver oxide valves.

Eight tests were performed using valves of different materials to test for measurable zones of inhibition. Sample discs were prepared of the various materials in the concentrations to be tested. The silver oxide, silver, copper, copper oxide, metallic copper, and gentian violet materials were mixed with silicone elastomer, in the concentrations listed. The SPIRE silver (SPIRE A and B), SPIRE Titanium, SPIRE copper were coatings on the valve using SPIRE's coating method. The novatran is a parylene coating and the BSI is a polyacrylamide coating, both done on the valves.

Cultures of Candida albicans were grown up for each test date. The Candida cultures were swabbed onto media plates and the sample discs were placed on the plates. The plates were incubated at the specified controlled temperature for 15-24 hours and the plates read for inhibition zones. The plates were then returned to the incubator until overgrown.

All tests were performed under the Class 100 laminar flow bench. Particle counting was performed on the clean bench prior to initiation of the testing.

Summary: Measurable zones of inhibition were demonstrated only on silver oxide, in both the 5% and the 10% concentrations, and on the 2% gentian violet. The zones of inhibition were consistently in the range of 5-7 mm around the test disc.

TESTING PERFORMED

| | |
|---|---|
| Test Samples | Inhibition |

1.

| | |
|---|---|
| 10% Ag₂O | Yes |
| 5% Ag₂O | Yes |
| 10% silver | |
| 5% silver | |
| Novatran | |
| BSI | |
| Q7-4750 (control) | |

2.

| | |
|---|---|
| New 10% Ag₂O | Yes |
| Old 10% Ag₂O | Yes |
| New 6% silver | |
| Q7-4750 (control) | |
| Old 10% silver^{xx} | |

^{xx}Old Ag₂O was taken from a bottle past the expiration date

| | |
|---|---|
| Test Samples* | Inhibition |

3.

| | |
|---|---|
| Ag₂O soaked | |
| in saline 1 week | Yes |
| SPIRE A | |
| SPIRE B | |

*Candida successfully rinsed off Ag₂O sample, but not off SPIRE
samples.

4.

0.5% Ag₂O
1.0% Ag₂O
5% Ag₂O
Q7-4750 (control)
10% Ag₂O

*No Inhibition; dilutions done incorrectly.
(SPIRE A is a very hydrophilic surface with moderately smooth surface;
SPIRE B is a moderate improvement in surface energy with a very smooth
surface)

| | |
|---|---|
| Test Samples | Inhibition |

5.

| | |
|---|---|
| 5% Cu | |
| 2% Cu | |
| 1% Cu | |
| 10% Ag₂O | Yes |
| Q7-4750 (control) | |
| 5% Ag₂O, soaked | |
| In saline for | |
| 18 weeks | |
| 0.5% Ag₂O | |

6.
No data recorded (when lab accident occurred)
7.

| | |
|---|---|
| 10% Ag₂O | Yes |
| 2% copper oxide | |
| SPIRE Ti | |
| SPIRE Cu | |
| 5% Metallic Cu | |
| Domed valve, | |
| Q7-4750 | |

8.

| | |
|---|---|
| 2% Gentian violet | Yes |
| SPIRE gold | |
| SPIRE Titanium | |
| Q7-4750 (control) | |

Based on the cytoxicity information and the results of the in-vitro tests, it was decided that the clinical units of the silicone elastomer bodies and 10% silver oxide valves, and SPIRE®-coated bodies with 10% silver oxide valves would be clinically tested.

Ten patients were given the clinical units under supervision.

STUDY RESULTS

| Patient | Control | Clinical Unit | | | | |
|---|---|---|---|---|---|---|
| Number | Time | Time | | Increase | | Device |
| 1 | 8 days | 49 | days | 41 | days | 10% Ag₂O |
| | 27 days | 36 | days | 9 | days | SPIRE-coated |
| | | | | | | Ag₂O |
| 2 | 59 days | 127 | days | 68 | days | 10% Ag₂O |
| | 36 days | | | | | |
| 3 | 28 days | 69 | days | 41 | days | 10% Ag₂O |
| | | 215+ | days | 187 | days | 10% Ag₂O |
| 4 | 22 days | 258+ | days | 236 | days | SPIRE-coated |
| 5 | 35 days | 42 | days | 7 | days | 10% Ag₂O |
| | | 61 | days | 26 | days | |
| 6 | 42 days | 13 | days | −29 | days | 10% Ag₂O |
| | 42 days | 33 | days | −9 | days | 10% Ag₂O |
| | | 38 | days | −4 | days | 10% Ag₂O |
| 7 | | 26 | days | | | 10% Ag₂O |
| | | 4 | days | | | Ag₂O valve/SPIRE |
| | | 10 | days | | | SPIRE-coated |
| 8 | | 222 | days | | | 10% Ag₂O |
| 9 | | 296 | days | | | 10% Ag₂O |
| 10 | | 98 | days | | | 10% Ag₂O |
| | | 287+ | days | | | 10% Ag₂O |

The 27 day sample used by patient #1 had the body SPI-Silicone coated to change its surface characteristics and the valve was silver oxide. Patient #4 used a voice prosthesis which had the body SPI-Silicone coated. Patients #8, #9 and #10 used voice prosthesis with standard silicone bodies and 10% concentration silver oxide valves.

Organic antimicrobial agents are readily and evenly dispersed in resin in amounts usually from 0.2 to 5 percent by weight.

Preferred Percentages of Additives

| | | Preferred |
|---|---|---|
| Triclosan | 0.25 to 5.0% | 0.50 to 3.0% |
| Butyl paraben | 0.25 to 3.0% | 0.50 to 2.0% |

Methods of Introduction:

There are three main methods of introduction of organic additives into the silicone elastomer material. The first method is simply mixing or milling the additives as a powder into silicone elastomer. This is done to either part of a two-part silicone elastomer system or to both parts together prior to molding. The problem with this method is the complete dispersion of the additive in the silicone.

The second method of introduction of the additive into silicone is to pre-dissolve the additive in a minimal amount of isopropanol or other appropriate solvent. This liquid mixture is then mixed or milled into the silicone as described above. The advantage to this method is that there is better dispersion of the additive within the silicone. One disadvantage is that it has been found that the addition of isopropanol negatively affects the physical properties of the finished, cured silicone. These effects are proportional to the amount of isopropanol added and can be minimized to negligible by the addition of only the minimal required isopropanol.

The third method is preferred as it allows dispersion of the additive throughout the silicone without the use of a solvent. This method is simply heating the additive above its melting temperature, but not past the decomposition temperature. It is then mixed into half of the two-part silicone at this temperature. The silicone is allowed to cool prior to mixing both parts together and molding. This method provides a uniform distribution of additive throughout the silicone matrix.

In one aspect, a first preferred method for making an antimicrobial elastomeric composition in accordance with the present technology comprises the steps of: (a) presenting Part A and Part B of a silicone elastomer wherein when Part A and Part B are mixed together in the presence of an initiator, a curable, injection moldable silicone elastomer is formed; (b) mixing part A with part B to form a liquid, moldable silicone elastomer; (c) dispersing additional inhibitor into the silicone elastomer wherein the inhibitor is any agent that affects the work-time of the liquid elastomer; and (d) compounding an antimicrobial agent into the liquid silicone elastomer.

The term “work-time,” as used herein, means the length of time after Part A and Part B of a two-part curable elastomer composition are admixed, so that the elastomer composition remains injection moldable at or near room temperature. Part A and Part B are preferably platinum cured and provide a silicone elastomer having a durometer between 40 and 70, and most preferably about 60, when cured. The term “inhibitor,” as used herein, refers to any substance that, when added to a silicone elastomer comprising a mixture of Part A and Part B, increases or extends the work-time (i.e., the time required for the elastomer to cure). An example of a suitable inhibitor is 2-methyl-3-butyn-2-ol. Although the amount of inhibitor incorporated into Part B of a two-part silicone elastomer by the manufacturer is generally maintained as a trade secret by the manufacturer, it is believed to be on the order of 0.02% w/w as supplied. The amount of additional inhibitor to be added to Part A and/or Part B, either prior to or after mixing, is related to the amount of work-time altering additive such as silver oxide added to the elastomer. The amount of additional inhibitor added to the silicone elastomer in accordance with the method of the present technology is optionally in the range of about 0.05-0.40% w/w, and preferably in the range about 0.05-0.1% w/w. In certain aspects, an amount of additional cure inhibitor that is added to a mixture of two-part silicone is at least of 1 mole of inhibitor to 6 moles of Ag₂O. In certain aspects, a mole ratio of the second amount of inhibitor to the work-time altering agent, silver oxide, is about 1:6 to about 1:40. A preferred mole ratio of additional inhibitor to silver oxide in the silicone elastomer is about 1:40.

In this manner, the pot life of the two-part silicone mixture is increased to 4 to 8 hours, for example, and the dispersion of the Ag₂O powder is uniform throughout the component. Such work-time extensions can be obtained, for example, by adding two drops of cure inhibitor per 100 grams of two-part silicone elastomer, such as NuSil™.

A second preferred method for making an antimicrobial elastomeric composition in accordance with the present technology comprises the steps of: (a) presenting Part A and Part B of a silicone elastomer wherein when Part A and Part B are mixed together in the presence of an initiator, a curable, injection moldable silicone elastomer is formed; (b) adding additional inhibitor to Part A or Part B; (c) dispersing particles of an antimicrobial agent in Part A or Part B; and (d) mixing Part A with Part B.

In yet a third preferred method for making an antimicrobial elastomeric composition in accordance with the present technology, the method comprises the steps of (a) presenting Part A and Part B of a silicone elastomer; again wherein when Part A and Part B are mixed together in the presence of an initiator, a curable, injection moldable silicone elastomer is formed; (b) adding additional inhibitor to both Part A and Part B; (c) dispersing particles of an antimicrobial agent in Part A or Part B; and (d) mixing Part A with Part B.

In all of the methods for making an antimicrobial silicone elastomer having an extended work-time in accordance with the present technology, the preferred antimicrobial agent is silver oxide. To form an elastomeric article by injection molding, the moldable elastomer comprising the article should be in a physical form (e.g., flowable) operable for conforming to the contour of a mold into which it is injected. In certain aspects, Part A and Part B of a curable silicone elastomer (where at least one of Part A and Part B includes a first amount of a first inhibitor); a second amount of a second inhibitor, and an antimicrobial work-time altering agent comprising silver oxide are mixed to form a curable and flowable silicone elastomer dispersion for injection molding. The second amount of the second inhibitor added during mixing is related to an amount of the antimicrobial work-time altering agent present in the dispersion and is effective to increase a work-time for injecting the dispersion. In the absence of the second amount of inhibitor, a comparative mixture of the Part A, the Part B, and the antimicrobial work-time altering agent comprising silver oxide has a comparative work-time that is generally much less than the work-time of the system having the second amount of inhibitor. The dispersion is injected into a mold for a component of the voice prosthesis device and conforms to a contour of the mold during injecting. The curable silicone elastomer dispersion is then cured to form the component, for example, the valve, valve seat, cartridge, and the like, having antimicrobial properties for the voice prosthesis device.

### EXAMPLES

### Example 1

Present 50 grams silicone part A; then
Add 50 grams of silicone part B to part A; then
Add 0.08 ml of inhibitor to the part A/part B mixture to provide a silicone elastomer; then
Disperse additional inhibitor throughout the part A/part B silicone elastomer; then
Add 7.5 grams silver oxide to the inhibitor/silicone elastomer mixture; then
Disperse silver oxide throughout the inhibitor/silicone elastomer mixture.

The work-time of the antimicrobial silicone elastomer thus formed is on the order of several hours to two days.

### Example 2

Present 50 grams of silicone part B; then
Add 0.12 ml of additional inhibitor to silicone part B; then
Disperse the additional inhibitor throughout part B; then
Add 11.1 grams silver oxide to the inhibitor/part B mixture; then
Disperse the silver oxide throughout inhibitor/part B mixture; then
Add 50 grams silicone part A to inhibitor/silver oxide/part B mixture; then
Disperse silicone part A throughout previous mixture.

Elastomers made in accordance with either Example 1 or Example 2 provide a viscous, injection-moldable antimicrobial composition having a work-time of several hours to two days.

While particular embodiments of the present technology have been illustrated and described, the present disclosure contemplates various other changes and modifications, which can be made without departing from the spirit and scope of the technology. For example, a further method for making an antimicrobial elastomeric composition may comprise the steps of: (a) presenting Part A and Part B of a silicone elastomer wherein when Part A and Part B are mixed together in the presence of an initiator, a curable, injection moldable silicone elastomer is formed; (b) adding additional inhibitor to Part A or Part B; (c) dispersing particles of an antimicrobial agent in Part A and Part B; and (d) mixing Part A with Part B.

The following voice prosthesis devices were constructed containing the indicated percent of antimicrobial agent according to the present disclosure. None of the following examples contain any antimicrobial agent in the silicone body.

Valve/Cartridge Valve Seat Table

The following voice prosthesis devices were constructed containing the indicated percent of antimicrobial agent according to the present teachings. None of the following examples contain any antimicrobial agent in the silicone body.

| | Valve | % | Cartridge Valve Seat | % |
|---|---|---|---|---|
| 1. | Ag₂O | 2 | | 0 |
| 2. | Ag₂O | 2 | Triclosan | 2 |
| 3. | Triclosan | 4 | Triclosan | 4 |
| 4. | Butyl Paraben | 2 | Triclosen | 4 |
| 5. | Ag₂O | 2 | Triclosan | 4 |
| 6. | Triclosan | 4 | Triclosan | 4 |
| 7. | Butyl Paraben | 2 | Triclosan | 4 |

Toxicity Testing:

Toxicity Testing Table

| | |
|---|---|
| Test | Results |

Triclosan:

| | |
|---|---|
| Cytotoxicity (MEM Elution) on the valve material alone | Toxic |
| Cytotoxicity (MEM Elution) on the device with valve | Nontoxic |
| material. | |
| Acute Oral Toxicity (7 day observation in the mouse) | Nontoxic |

Butyl Paraben

| | |
|---|---|
| Cytotoxicity (MEM Elution) on the device with valve | Nontoxic |
| material. | |
| Acute Oral Toxicity (7 day observation in the mouse) | Nontoxic |

Zone of Inhibition Data

Preface:

In each of these cases, unless noted, a sample of silicone with respective additive was punched from a slab. The final dimensions of the sample pieces were roughly 5 mm in diameter by 2 mm thick. Each variation of these samples were placed separately in 0.45 saline solution and incubated at 37° C. At the specified time, a sample was taken out of the solution and evaluated for zone of inhibition.

In each of the cases below, the testing organisms was Candida albicans, ATCC 10231. The medium used was Sabouraud's dextrose agar. Incubation time was 18 to 24 hours at 37° C. The zone of inhibition test was performed per internal testing standards of Helix Medical, Inc. The base material was Nusil™ MED 4940 silicone.

The zone of inhibition test technically measures leachability of an antimicrobial from a test article. The samples are placed on a lawn of microbial organisms of choice. As the substance leaches from the test sample, there is a concentration gradient set up as a function diffusion through the sample and diffusion away from the sample. At a certain concentration, a critical concentration, the growth of microorganisms will be greatly reduced. This is manifest as no growth or greatly reduced growth in a radius around the sample. With the purpose of the technology in mind, the size of the zone of inhibition is relatively unimportant, as long as the longevity of the substance with some microbial activity is maintained over time in a soaking condition. The result chosen to signify acceptable antimicrobial activity is inhibition of microbial growth underneath the sample. This signifies that the concentration at the surface of the sample has retained at least the critical concentration of antimicrobial substance. If the surface concentration can be maintained at or above the critical concentration, then little to no growth will colonize on the surface of this material.

Note: For inhibition underneath sample, it is measured either as Inhibition (I), Partial Inhibition (PI), or No Inhibition (NI).

Triclosan 0.5%:

| | | Inhibition |
|---|---|---|
| Time Soaked | Zone of | Underneath Sample |
| (weeks) | Inhibition (mm) | (I, PI, NI) |
| 1 day | 0 | I |
| 1 | 0 | I |
| 2 | 0 | I |
| 3 | 0 | I |
| 4 | 0 | I |
| 12 | 0 | I |
| 16 | 0 | I |

Triclosan 1.0%:

| | | Inhibition |
|---|---|---|
| Time Soaked | Zone of | Underneath Sample |
| (weeks) | Inhibition (mm) | (I, PI, NI) |
| 1 day | 1 | I |
| 1 | 1 | I |
| 2 | 1 | I |
| 3 | 1 | I |
| 4 | 1 | I |
| 8 | 1 | I |
| 12 | 1 | I |
| 16 | 0.5 | I |

Triclosan 2.0%:

| | | Inhibition |
|---|---|---|
| Time Soaked | Zone of | Underneath Sample |
| (weeks) | Inhibition (mm) | (I, PI, NI) |
| 1 day | 1 | I |
| 1 | 1 | I |
| 2 | 1 | I |
| 3 | 1 | I |
| 11 | 1 | I |
| 12 | 1 | I |
| 16 | 1 | I |
| 20 | 1 | I |
| 24 | 1 | I |

Triclosan 2.0% molded valves:

| | | Inhibition |
|---|---|---|
| Time Soaked | Zone of | Underneath Sample |
| (weeks) | Inhibition (mm) | (I, PI, NI) |
| 1 day | 1 | I |
| 1 | 1 | I |
| 2 | 1 | I |
| 3 | 1 | I |
| 4 | 1 | I |
| 8 | 1 | I |

Butyl paraben 1%:

| | | Inhibition |
|---|---|---|
| Time Soaked | Zone of | Underneath Sample |
| (weeks) | Inhibition (mm) | (I, PI, NI) |
| 1 day | 1.5 | I |
| 1 | 1.5 | I |
| 2 | 1.5 | I |
| 3 | 2 | I |
| 4 | 2 | I |
| 8 | 2 | I |
| 12 | 1 | I |
| 16 | 1 | I |

Butyl Paraben 1% molded valves:

| | | Inhibition |
|---|---|---|
| Time Soaked | Zone of | Underneath Sample |
| (weeks) | Inhibition (mm) | (I, PI, NI) |
| 1 day | 0 | I |
| 1 | 0 | I |
| 2 | 0 | I |
| 3 | 0 | I |
| 4 | 0 | I |
| 8 | 0 | PI |

Voice prostheses formed with microbial resistant valves will be able to be used for much longer periods, without the need to remove the prosthesis for cleaning. The prosthesis can be made with thinner valves, body and flanges since there is no need to be as stiff and rigid to avoid bending and wrinkling due to growth of Candida Albicans. The body of the voice prosthesis can also be compounded with antimicrobial agents at a level acceptable to the U.S. Food and Drug Administration (FDA).

The Indwelling Low Pressure Voice Prosthesis of the technology is designed for those persons who are unable or resistant to changing the voice prosthesis every two or three days as was recommended for the non-indwelling, patient-removable Low Pressure Voice Prosthesis. The Indwelling Low Pressure Voice Prosthesis has been specifically designed to maintain the placement of the prosthesis in the tracheoesophageal puncture so that routine changing of the device is not necessary.

It is to be realized that only preferred embodiments of the technology have been described and that numerous substitutions, modifications and alterations are permissible without departing from the spirit and scope of the technology as defined in the following claims.

What is claimed is:

1. A method for making an antimicrobial component for a voice prosthesis device comprising:
(a) mixing part A and part B of a silicone elastomer, an antimicrobial work-time altering agent comprising silver oxide; and an inhibitor to form a curable elastomer mixture, wherein at least one of Part A and Part B includes an initial amount of an initial inhibitor and said inhibitor added during said mixing is provided at a second amount effective to increase a work-time of the curable elastomer mixture; and
(b) forming a component having antimicrobial properties for the voice prosthesis device by curing the silicone elastomer mixture.

2. A method of claim 1, wherein said component is a valve element.

3. A method of claim 2, wherein said valve element comprises a valve flap.

4. A method of claim 3, wherein said valve element comprises said valve flap connected to a hinge segment.

5. A method of claim 3, wherein said valve element is a valve flap connected to a hinge segment further connected to an outer mounting band.

6. A method of claim 1, wherein said component is a tubular body portion of the voice prosthesis device.

7. A method of claim 1, wherein said forming is injection molding.

8. A method of claim 1, wherein said second amount of inhibitor that increases a work-time of the curable silicone elastomer is about 0.05 to about 0.40 weight % of said curable elastomer mixture and relates to an amount of said antimicrobial work-time altering agent present in said elastomer mixture.

9. A method of claim 1, wherein said second amount of inhibitor that increases a work time of the curable silicone elastomer is about 0.05 to about 0.1 weight % of said curable elastomer mixture and relates to an amount of said antimicrobial work-time altering agent present in said elastomer mixture.

10. A method of claim 1, wherein said inhibitor introduced as said second amount during mixing comprises 2-methyl-3-butyn-2-ol.

11. A method of claim 1, wherein said antimicrobial work-time altering agent comprising silver oxide is present at about 1 to about 50 parts per hundred resin (phr) of silicone elastomer and a mole ratio of said second amount of an inhibitor to silver oxide is about 1:6 to about 1:40.

12. A method of claim 1, wherein said second amount of said inhibitor added to either Part A or Part B is present at a mole ratio of about 1:6 to about 1:40 of said second inhibitor to said antimicrobial work-time altering agent comprising silver oxide, such that said second amount of inhibitor is effective to increase a work-time of the curable silicone elastomer comprising the antimicrobial work-altering agent prior to said curing.

13. A method for making an antimicrobial valve element for a voice prosthesis device comprising:
(a) mixing part A and part B of a silicone elastomer, an antimicrobial work-time altering agent comprising silver oxide; and an inhibitor to form a curable elastomer mixture, wherein at least one of Part A and Part B includes an initial amount of an initial inhibitor and said inhibitor added at said mixing is provided at a second amount effective to increase a work-time of the curable elastomer mixture; and
(b) forming a valve element comprising a valve flap having antimicrobial properties for the voice prosthesis device by curing the silicone elastomer mixture.

14. A method of claim 13, wherein said valve element comprises said valve flap connected to a hinge segment.

15. A method of claim 13, wherein said valve element is a valve flap connected to a hinge segment further connected to an outer mounting band.

16. A method of claim 13, wherein said component is a tubular body portion of the voice prosthesis device.

17. A method of claim 13, wherein said forming is injection molding.

18. The method of claim 13, wherein said mixing further comprises combining said Part A with said Part B, then adding said second amount of said second inhibitor, followed by adding said antimicrobial work-time altering agent.

19. A method for injection molding an antimicrobial component for a voice prosthesis device, the method comprising:
presenting Part A and Part B of a curable silicone elastomer wherein at least one of Part A and Part B includes a first amount of a first inhibitor;
mixing said Part A, said Part B, a second amount of a second inhibitor, and an antimicrobial work-time altering agent comprising silver oxide, to form a curable and flowable silicone elastomer dispersion for injection molding, wherein said second amount of said second inhibitor is related to an amount of said antimicrobial work-time altering agent present in said dispersion and is effective to increase a work-time for injecting said dispersion, wherein in the absence of said second amount of inhibitor, a comparative mixture of said Part A, said Part B, and said antimicrobial work-time altering agent comprising silver oxide has a comparative work-time that is less than said work-time;
injecting said dispersion into a mold for a component of the voice prosthesis device, wherein said dispersion conforms to a contour of said mold during said injecting; and
curing said curable silicone elastomer dispersion to form the component having antimicrobial properties for the voice prosthesis device.

20. The method of claim 19, wherein said second amount of said second inhibitor that increases a work-time is about 0.05 to about 0.1 weight % of said curable silicone elastomer dispersion and relates to an amount of said antimicrobial work-time altering agent present in said dispersion.
